(19) United States
(12) Patent Application Publication
(10) Pub. No.: US 2017/0205545 A1
(43) Pub. Date: Jul. 20, 2017

(54) A METHOD OF MANUFACTURING A COMBINED PHOTOLUMINESCENT AND RETROFLECTIVE SHEET MATERIAL

(71) Applicant: NKR (Cheshire) Limited, Crewe, Cheshire (GB)

(72) Inventor: Nicholas James Rowbottom, Crewe, Cheshire (GB)

(21) Appl. No.: 15/328,862

(22) PCT Filed: Jul. 23, 2015
(86) PCT No.: PCT/GB2015/052140

§ 371 Date: Jan. 24, 2017

(30) Foreign Application Priority Data
Jul. 24, 2014 (GB) 1413130.4

(51) Int. Cl. G02B 5/12; A41D 13/01; A41D 1/04; B29D 11/00

(52) U.S. Cl. CPC G02B 5/12; B29D 11/00605; A41D 13/01; A41D 1/04

(57) ABSTRACT

A method of manufacturing a combined photoluminescent and retroreflective sheet material is disclosed. The method comprises the coating of at least part of one side of a sheet of a substrate (3) such as a fabric substrate, with a mixture of an adhesive and a photoluminescent pigment. The mixture preferably comprises between 20% and 70% inclusive of a photoluminescent pigment having a size between 20 microns and 60 microns inclusive. The adhesive is preferably a transparent adhesive. The coated sheet of substrate (7) is then cured prior to the securement of one or more pieces of a retroreflective sheet (9) o one or more predetermined areas of said one side of the sheet of the substrate to form the sheet material such that at least 5% of visible area of said one side of the sheet material is photoluminescent.

The present invention relates to a method of manufacturing a photoluminescent and reflective sheet material, in particular one in tape form, that may be used primarily but not exclusively in the manufacture of high visibility clothing and to a combined photoluminescent and reflective sheet material.

High visibility clothing comprises warning clothing intended to provide improved conspicuity in situations where the risk of not being seen is high. Such clothing, which typically comprises vests, waistcoats, jackets, and over-trousers, is designed to provide three classes of high visibility based on three different minimum areas of retroreflective, fluorescent and/or combined performance materials. The standards for each of these classes are such that the garment, headwear or footwear has to provide a predefined level of conspicuity against most backgrounds found in urban and rural situations in daylight and in night time. Conspicuity is determined by an object's luminance contrast, colour contrast, pattern and design, and motion characteristics relative to the ambient background against which it is seen. In a combined performance garment, appropriate areas thereof have to provide the specified level of retroreflection and fluorescence, which is usually supplied by retroreflective and fluorescent tapes that are sewn or otherwise secured to the garment. These tapes are usually either retroreflective or fluorescent but not both. This means that in the manufacture of a combined performance garment two types of tape have to be applied to it, resulting in such garments being relatively expensive and time-consuming to produce.

Retroreflective materials are those that reflect light back to its source with a minimum of scattering. Typically, they comprise retroreflective glass beads, microprisms, or encapsulated lenses that are sealed onto a fabric or plastic substrate, for example as described in WO94/25666.

Fluorescent materials are those that emit electromagnetic radiation at visible wavelengths longer than those absorbed. In high visibility clothing preferably the fluorescent materials used are photoluminescent, that is that they emit visible light after absorption of photons (after photoexcitation). The period between absorption and emission of photons can be extremely short or can be extended into minutes or hours in particular circumstances. For some applications the fluorescent materials are preferably not only photoluminescent but also phosphorescent. Phosphorescence is a specific type of photoluminescence wherein the radiation absorbed is not emitted immediately but emitted over a longer time scale. Such phosphorescent materials can be “charged up” during daytime wear and then emit light for a predetermined period in the dark.

Combined photoluminescent and retroreflective tapes are known wherein retroreflective elements, usually microprisms, are embedded into a plastics material that also contains photoluminescent pigments. However, these tapes do not meet international standards for retroreflection because operation of the retroreflective elements is impaired by the plastics material in which they are embedded.

The object of the present invention is to provide a method of manufacturing a combined photoluminescent and retroreflective sheet material, in particular one in tape form, that is suitable for use in the manufacture of high visibility clothing and that is capable of meeting international standards, specifically EN20471-2013 and ANSI/ISEA 107-2010.

According to a first aspect of the present invention there is provided a method of manufacturing a combined photoluminescent and retroreflective sheet material comprising the steps of
coating at least a part of one side of a sheet of a substrate with a mixture of an adhesive and a photoluminescent pigment;
curing the coating; and
securing one or more pieces of a retroreflective sheet to one or more predetermined areas of said one side of the sheet of the substrate to form the sheet material such that at least 5% of visible area of said one side of the sheet material is photoluminescent.

The method is suitable for the production of materials which are photoluminescent or phosphorescent, the photoluminescent pigment being chosen appropriately.

Preferably, the mixture comprises between 20% and 70% inclusive of a photoluminescent pigment comprised of particles having a size of up to 150 μm. Advantageously, the mixture comprises 50% of a photoluminescent pigment that preferably has a particle size between 20 μm and 60 μm inclusive. Such a size gives a good packing density of the particles of pigment to ensure that the photoluminescence is even across the area of the substrate.

The adhesive with which the photoluminescent pigment is mixed should preferably be a transparent adhesive so that the photoluminosity of the finished material is not impaired. Adhesives comprising resins such as vinyl, acrylic, urethane, epoxy, polyester and alkyd resins are all suitable and may be are formulated into a printable liquid at a viscosity and rheology applicable to the coating process being used. Preferably, the adhesive is cured by being subjected to heat or UV radiation and cross-links so that it can be remelted after curing. In order to achieve a fully cured coating, it is important to coat the fabric substrate with an even coating having a predetermined thickness. Too thick a coating may result in a poor cure or polymerization of the coating. Hence, the substrate is preferably coated with a coating weight of between 200 g/m² and 750 g/m2. Advantageously the coating weight is 350 g/m² using a mixture that comprises at least 50% photoluminescent pigment comprised of particles having a size between 20 μm and 60 μm inclusive.

The substrate is preferably a fabric such as a woven cotton or woven polyester cotton fabric. To achieve the best results from the photoluminescent pigment, preferably the substrate is a white fabric. The photoluminescence of the coated pigment may also be further improved by pre-coating or impregnating the fabric substrate with titanium dioxide, which gives the substrate a “super white” finish. This improves the glow intensity of the photoluminescent coating. Glow intensity is also improved if the substrate is comprised of a blackout fabric or has a blackout fabric backing on the side opposite that coated with the photoluminescent coating. This is because light cannot pass through the substrate and is reflected back into the coated side. Also, while the photoluminescent glow is usually green, it has been found that in some embodiments the use of a brightly coloured substrate enables the colour of the photoluminescent glow to be changed without any need to add a coloured pigment to the coating, which would impair the photoluminescent performance of the coating.

Alternatively, the substrate may comprise a non-woven sheet material, for example a non-woven fabric or a plastics sheet.

Preferably, the photoluminescent pigment is phosphorescent and comprises strontium aluminate. Such pigments are known that emit visible light for up to several hours after exposure to daylight.

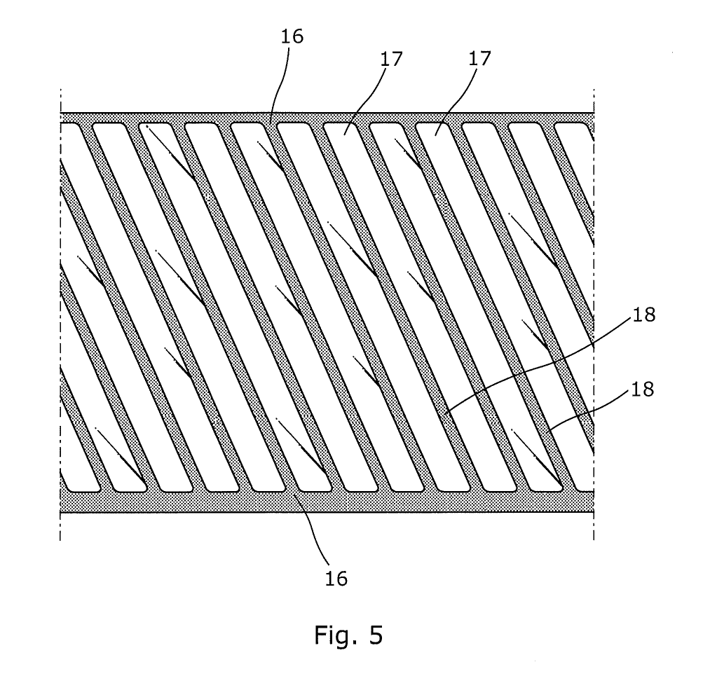

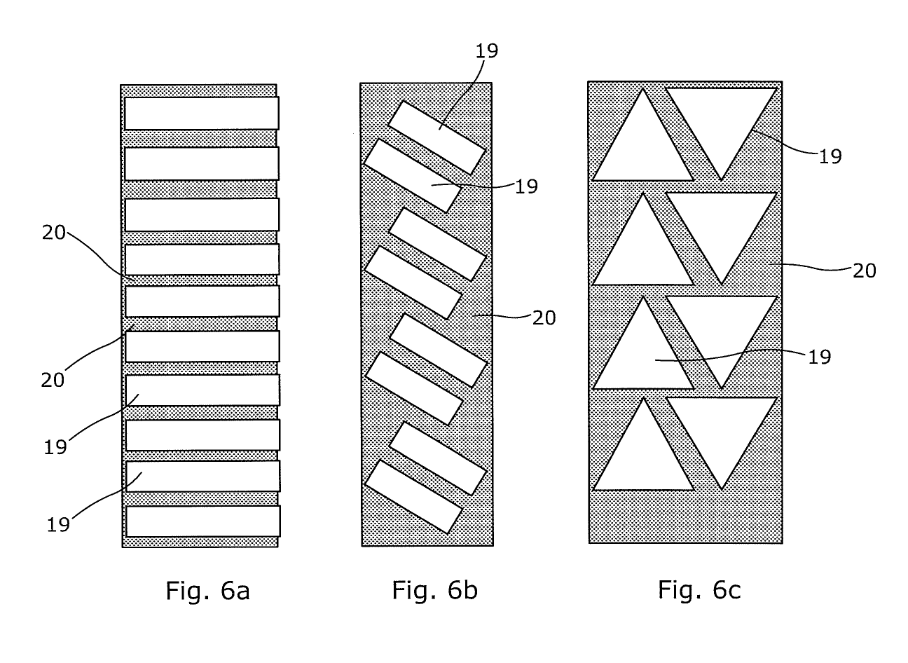

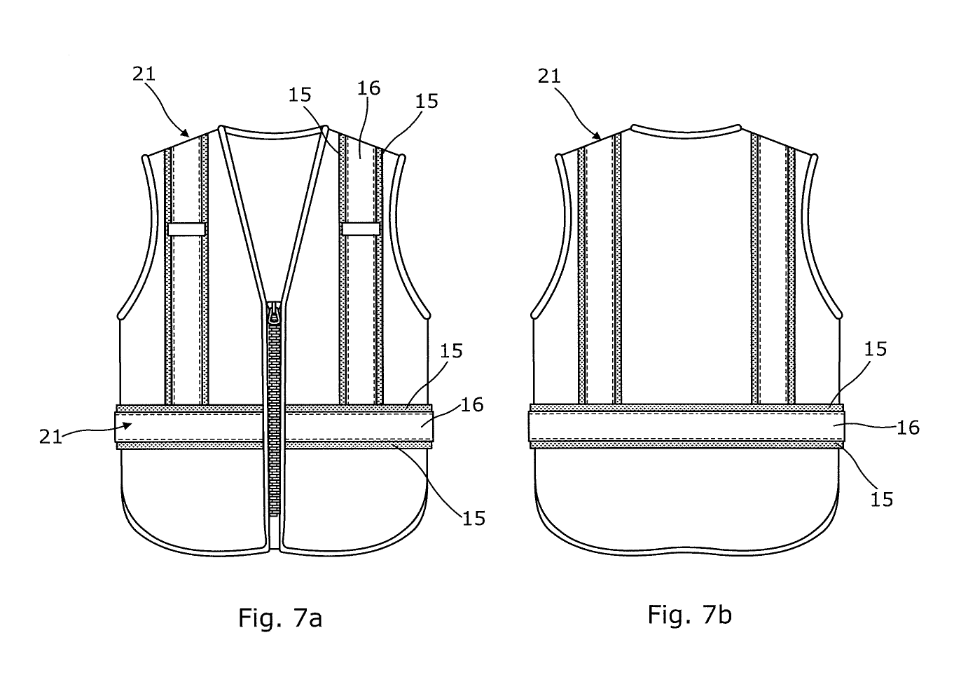

In order to make a photoluminescent and reflective sheet material in the form of a tape that may then be used in the manufacture of high visibility clothing, for example as described below with reference to FIGS. 7a and 7b, the fabric substrate may be coated with the mixture of adhesive and photoluminescent pigment in stripes, which may be between 5 mm and 75 mm inclusive wide and between 5 mm and 75 mm inclusive apart. The retroreflective sheet is then applied and secured to the substrate in strips in the gaps between the photoluminescent stripes. This means that the photoluminescent pigment is not wasted by being located behind the retroreflective sheet in use. However, in other embodiments, for example as described below with reference to FIGS. 5, 6a, 6b and 6c, the substrate is completely covered by the coating and the retroreflective material is applied in discontinuous segments in predetermined positions over the top of it.

Prior to securement of the retroreflective material, the coated substrate may be cut up to produce strips to which strips of the retroreflective material are applied and secured to produce sheet material in the form of a tape, including a transfer tape as described below.

Preferably, the retroreflective sheet is applied to the coated substrate in strips that are at least 20 mm wide. Advantageously, the strips are 25 mm (1 inch), 35 mm or 50.08 mm (2 inches) wide as these widths satisfy most international standards for use of the finished material as a tape for use on high visibility clothing.

Retroreflective sheets in the form or rolls or tapes in the form of a transfer film are known. These may be applied directly to the coated substrate and secured thereto by an adhesive, which is preferably heat-activatable adhesive or a pressure sensitive adhesive. Conventional, commercially available products of this type comprise tapes with discontinuous retroreflective segments that are removable disposed on a carrier film, for example in angled stripes across the width of the film. Such transfer films may be heat laminated to a photoluminescent substrate by heat press lamination methods and the carrier film thereafter removed to leave discontinuous retroreflective segments secured to the substrate. Alternatively, retroreflective sheets in appropriate shapes or in roll or tape form may be secured by adhesive or by being sewn to the photoluminescent substrate.

It is important when the transfer film is being applied to the substrate that the heat-sensitive adhesive used has an activation temperature which is sufficient to adhere the transfer film to the substrate but does not also melt the transparent adhesive that is mixed with the photosensitive pigment. Preferably, therefore, the mixture includes a catalyst that cross-links the adhesive when the mixture is cured so that it cannot be remelted. Alternatively or in addition the heat-sensitive adhesive forming part of the transfer tape preferably has an activation temperature that is lower than that of the transparent adhesive used in the mixture. For example, the former may be 120°C and the latter 160° C.

In order to be effective in use, at least 5% of the visible area of the photoluminescent and retroreflective material should by photoluminescent. In tapes produced for use on high visibility clothing, the photoluminescent areas may comprise the two borders along opposite edges the tape, the central area of the tape comprising a strip of retroreflective material or a series of discontinuous retroreflective segments as described above. These borders are preferably at least 5 mm wide, the central area comprising the retroreflective material being at least 20 mm wide.

According to a second aspect of the present invention there is provided a combined photoluminescent and retroreflective sheet material comprising a sheet of a substrate coated on at least one side with a mixture of a transparent adhesive and a photoluminescent pigment and over which has been secured a retroreflective sheet in one or more predetermined areas of said one side such that at least 5% of the visible area of said one side is photoluminescent.

In many applications, the sheet material produced is simply attached by sewing it to an underlying garment or other item. However, it is possible to produce a sheet material that is a transfer, for example in the form of a transfer tape, so that it may be adhered to another item. This is achieved by coating the other side of the sheet of substrate with a pressure-sensitive adhesive that is then covered by a release material, which is peeled off when it is desired to adhere the sheet material to an item.

Other preferred but non-essential features of the present invention are described in the dependent claims appended hereto.

The present invention will now be described by way of example with reference to the accompanying drawings, in which:

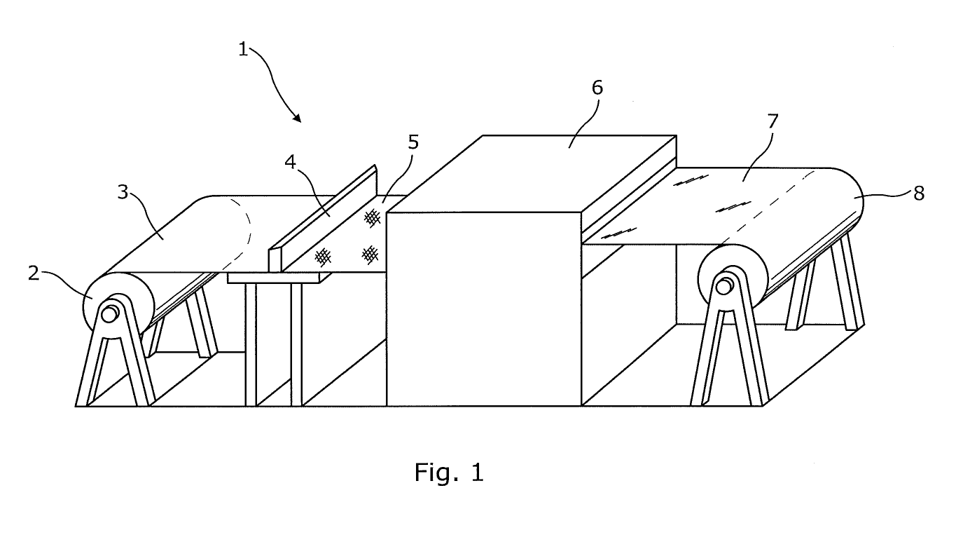

FIG. 1 is a schematic perspective view of apparatus for use in a first part of a manufacturing process to produce a combined photoluminescent and retroreflective sheet material in accordance with the present invention;

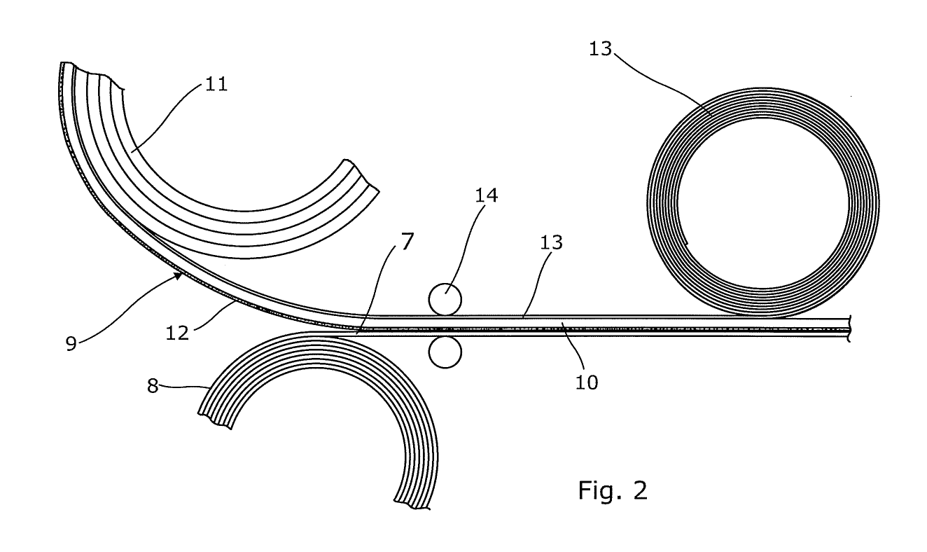

FIG. 2 is a schematic perspective view of apparatus for use in a second part of the manufacturing process, the dimensions of layers of the sheet material shown being exaggerated for clarity;

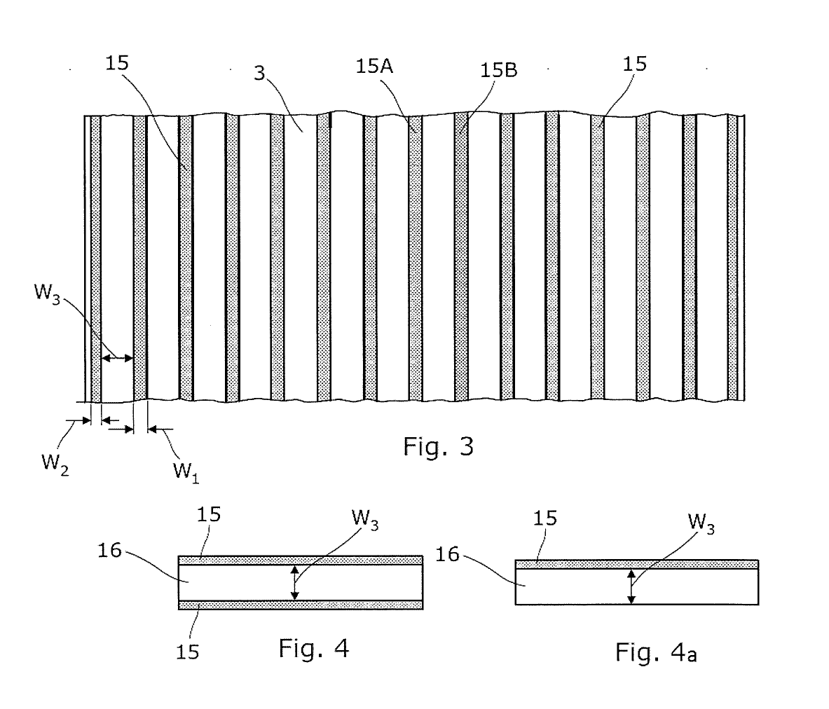

FIG. 3 is a diagram of one side of a substrate forming part of the sheet material showing a pattern used for a photoluminescent coating;

FIG. 4 is a diagram of one side of an embodiment of a combined photoluminescent and retroreflective sheet material in the form of a tape;

FIG. 4a is a diagram similar to FIG. 4, but of another embodiment of tape;

FIG. 5 is a diagram similar to FIG. 4 but of another embodiment of tape;

FIGS. 6a, 6b and 6c are diagrams similar to FIG. 5 showing three alternative arrangements; and

FIGS. 7a and 7b are front and rear views of a high visibility vest including areas of tape as shown in FIG. 4 thereto.

With reference to FIG. 1, a first part of a method for manufacturing a combined photoluminescent and retroreflective sheet material is shown that uses an air knife coating apparatus 1. Here, a roll of blackout fabric 2 is used to supply a sheet of a substrate 3 that is passed under an air knife 4 to be coated with a mixture of a transparent adhesive and a photoluminescent pigment. The air knife 4 is of conventional form wherein the coating is applied to the substrate 3 and spread to a predetermined thickness by the knife 4 which is set so that its edge is this predetermined distance above the substrate 3. This produces an even coating across the substrate 3. After passing under the air knife 4 the coated substrate 5 is fed into a curing oven 6. Dependent on the type of adhesive that forms part of the coating, the curing oven 6 either heats the coated substrate 5 to cure the coating or irradiates it with UV radiation. The coated substrate 7 emerging from the oven 6 is then fed onto a roll 8 to complete the first part of the manufacturing process wherein the photoluminescence is applied to the substrate. As described below, in some embodiments, the photoluminescent coating may be applied in stripes along the length of the substrate 3. This may be accomplished using a slot die coating process.

The next step in the manufacturing process is to apply a retroreflective material to the coated substrate. One method of accomplishing this is shown in FIG. 2. Here, a retroreflective sheet in the form of a tape 9 of transfer film to which a strip of retroreflective material 10, which may comprise a series of retroreflective segments (see segments 17 in FIGS. 5, 6a, 6b and 6c), has been applied is fed from a roll 11 and applied to the coated side of the substrate 7 which is taken from a roll such as the roll 8, as described above. The tape 9 has an adhesive 12 pre-applied to its back surface, which is that facing the substrate 7, and has a carrier film 13 covering the retroreflective material 10. The adhesive 12 is pressure and/or heat sensitive. The substrate ii and overlying tape 9 are then led between nip rollers 14, which may be heated. The nip rollers 14 activate the adhesive and cause the retroreflective material 10 of the tape 9 to be adhered to the substrate 11.

Finally, the overlying carrier film 13 is removed to leave a photoluminescent and reflective sheet material in accordance with the invention. If the photoluminescent coating has been applied to the substrate in stripes, then several tapes 9 of transfer film may be applied to the coated substrate 7 simultaneously across its width, typically in uncoated areas. In this case, after application of the retroreflective material, the finished material has to be cut into separate tapes. Alternatively, the coated substrate 7 may be cut into strips prior to application of the tape 9 of transfer film thereto so that each strip of substrate 7 is then individually overlaid by a tape 9.

As described above, in the first process, the substrate 3 may be coated over the whole of one side with the photoluminescent mixture. Alternatively, if it is desired to produce finished material in tape form then the mixture may be applied to the substrate 3 in stripes as shown in FIG. 3. Here longitudinal stripes 15 of the mixture are applied across the width of the substrate 3. The stripes themselves can be of any desired width but to produce tapes suitable for use on high visibility clothing each stripe preferably has a width W₁ of at least 20 mm with the stripes 15 at each longitudinal edge of the substrate have a width W₂ half that of W₁ , namely 10 mm in the present example. The distance W₃ between adjacent stripes 15A, 15B is preferably at least 20 mm wide but is most likely to be 25 mm (1 inch), 35 mm or 50.08 mm (2 inches) wide to meet most international standards for tapes used on high visibility clothing as the width W₃ is identical to the width of the retroreflective material that is to be applied to cover it. The width W₃ should be selected to satisfy the required standard for use of the finished material but it will be appreciated that the relative dimensions of the retroreflective material and substrate and in particular the widths W₁, W₂ and W₃ may be varied as required. Once coated, the substrate may be cut into separate strips down the middle of the stripes 15 to produce tapes as shown in FIG. 4, for example that have a 10 mm wide stripe 15 of photoluminescent coating down each side and a 50.08 mm strip down the centre that is then covered by retroreflective material 16 as described above.

In an alternative arrangement as shown in FIG. 5, the substrate is coated over the whole of one side with the photoluminescent mixture and is still cut into strips that are, for example, 60.08 mm wide similar to those shown in FIG. 4. Here, a 50.08 mm strip of retroreflective material is secured down the centre of each strip to leave 5 mm wide borders of photoluminescent coating 16 down each side of the tape, as in FIG. 4. Alternatively, and as shown in FIG. 4a, a 50.08 mm strip of retroreflective material is secured along one longitudinal edge of each strip to leave a 10 mm border of photoluminescent coating 16 down one side of the tape only. As shown in FIG. 5, the retroreflective material in the central area between the borders is not continuous but comprises discontinuous retroreflective segments 17 that are disposed in angled stripes across the width of the central area. As the underlying substrate 18 is fully photoluminescent, the central area has discontinuous retroreflective areas, provided by the segments 17, located between photoluminescent areas 18. Although the retroreflective segments 17 are in the form of stripes in FIG. 5, it will be appreciated that they could be made in any suitable shape or size and angled in any direction, for example as shown in FIGS. 6a, 6b and 6c wherein the retroreflective segments are labelled 19 and the underlying photoluminescent substrate is labelled 20. The retroreflective segments 17 may take the form of chevrons.

Finally, if it is desired to produce a transfer tape, the side of the substrate opposite that covered by the retroreflective material may also be coated with a heat-sensitive adhesive with the appropriate properties as previously mentioned.

In use, a combined photoluminescent and retroreflective sheet material in accordance with the invention may be used in variety of situations, in particular in signage and in high visibility clothing. A vest suitable for use as a high visibility garment is shown in FIGS. 7a and 7b. photoluminescent and retroreflective sheet material in the form of tapes 21, as described above with reference to FIG. 4, have been applied to its front and back in appropriate areas in accordance with international or local standards. The tape 21 is preferably sewn to the garment through the photoluminescent strips 15 at the edges of the tape 21 leaving the retroreflective central stripes 16 undamaged by stitching. This minimizes interference with the retroreflective areas. It will be appreciated that tapes 21 with other patterns of photoluminescence and retroreflectivity could be used, as appropriate. In other applications, for example signage, the combined photoluminescent and retroreflective sheet material may be adhered, stapled or otherwise applied to appropriate surfaces and backing sheets.

1. A method of manufacturing a combined photoluminescent and retroreflective sheet material comprising the steps of
coating at least part of one side of a sheet of a substrate with a mixture of an adhesive and a photoluminescent pigment;
curing the coating; and
securing one or more pieces of a retroreflective sheet to one or more predetermined areas of said one side of the sheet of the substrate to form the sheet material such that at least 5% of visible area of said one side of the sheet material is photoluminescent.

2. A method as claimed in claim 1, wherein the mixture comprises between 20% and 70% inclusive of a photoluminescent pigment comprised of particles having a size of up to 150 μm.

3. A method as claimed in claim 2, wherein, the mixture comprises 50% of the photoluminescent pigment.

4. A method as claimed in claim 1, wherein the pigment is comprised of particles having a size between 20 μm and 60 μm inclusive.

5. A method as claimed in claim 1, wherein the photoluminescent pigment is phosphorescent.

6. A method as claimed in claim 5, wherein the photoluminescent pigment comprises strontium aluminate.

7. A method as claimed in claim 1, wherein the adhesive is a transparent adhesive.

8. A method as claimed in claim, wherein after curing the adhesive is cross-linked.

9. A method as claimed in claim 1, wherein the substrate is coated with a coating weight of between 200 g/m2 and 750 g/m2.

10. A method as claimed in claim 9, wherein the coating weight is 350 g/m2 using a mixture that comprises at least 50% photoluminescent pigment comprised of particles having a size between 20 μm and 40 μm inclusive.

11. A method as claimed in claim 1, wherein the substrate is a fabric substrate.

12. A method as claimed in claim 11, wherein the substrate is a woven cotton fabric or a woven polyester cotton fabric.

13. A method as claimed in claim 1, wherein the substrate is a white fabric.

14. A method as claimed in claim, comprising the additional initial step of coating or impregnating the fabric substrate with titanium dioxide.

15. A method as claimed in claim 1, wherein the substrate is comprised of a blackout fabric or a blackout fabric backing on a side opposite that which is coated with the photoluminescent coating.

16. A method as claimed in claim 1, comprising the additional step of coating the other side of the sheet of the substrate with a pressure-sensitive adhesive.

17. A method as claimed in claim 1, wherein the fabric substrate is coated with the mixture of adhesive and photoluminescent pigment in the form of stripes.

18. A method as claimed in claim 17, wherein the stripes are between 5 mm and 75 mm inclusive wide and between 5 mm and 75 mm inclusive apart.

19. A method as claimed in claim 17, wherein the retroreflective sheet is applied and secured to the substrate in strips in the gaps between the photoluminescent stripes.

20. A method as claimed in claim 1, comprising the additional step of cutting the coated substrate up to produce at least one strip to which the retroreflective material is applied and secured to produce sheet material in the form of a tape.

21. A method as claimed in claim 20, wherein the retroreflective sheet is applied to the coated substrate in strips that are at least 20 mm wide.

22. A method as claimed in claim 1, wherein the retroreflective sheet is in the form of a transfer film that is applied directly to the coated substrate and adhered thereto.

23. A method as claimed in claim 22, wherein the transfer film is secured to the coated substrate by a heat-sensitive adhesive that has an activation temperature that is lower than that of the adhesive forming part of said mixture.

24. A method as claimed in claim 22, wherein the transfer film comprises discontinuous retroreflective segments that are removable disposed on a carrier film.

25. A method as claimed in claim 24, wherein the transfer film is heat press laminated to the coated substrate and the carrier film is thereafter removed to leave the discontinuous retroreflective segments secured to the substrate.

26. A method as claimed in claim 1, wherein the material is manufactured in the form of a tape and the photoluminescent visible area comprises a border along one longitudinal edge of the tape.

27. A method as claimed in claim 1, wherein the material is manufactured in the form of a tape and the photoluminescent visible area comprises two borders along opposite edges of the tape.

28. A method as claimed in claim 27, wherein the borders are at least 5 mm wide and at least 20 mm apart.

29. A combined photoluminescent and retroreflective sheet material comprising a substrate coated on at least one side with a mixture of a transparent adhesive and a photoluminescent pigment and over which has been secured a retroreflective sheet in one or more predetermined areas of said one side such that at least 5% of the visible area of said one side is photoluminescent.

30. A method of manufacturing a combined photoluminescent and retroreflective sheet material substantially as described herein with reference to the accompanying drawings.

31. (canceled)
